(19) United States
(12) Patent Application Publication
(10) Pub. No.: US 2015/0208404 A1
(43) Pub. Date: Jul. 23, 2015

(54) SYSTEM AND METHOD FOR PRIORITY DATA TRANSMISSION ON LTE DUAL CONNECTIVITY

(71) Applicant: Humax Holdings Co., Ltd., Yongin-si (KR)

(72) Inventors: Alex Chungku YIE, Incheon (KR); Yongjae LEE, Seongnam-si (KR); Jun Bae AHN, Gwangju-si (KR)

(21) Appl. No.: 14/603,156

(22) Filed: Jan. 22, 2015

(30) Foreign Application Priority Data
Jan. 23, 2014 (KR) 10-2014-0008371
May 16, 2014 (KR) 10-2014-0058952
May 16, 2014 (KR) 10-2014-0058953
May 16, 2014 (KR) 10-2014-0058954
Aug. 21, 2014 (KR) 10-2014-0109030
Aug. 21, 2014 (KR) 10-2014-0109031
Aug. 21, 2014 (KR) 10-2014-0109032
Aug. 22, 2014 (KR) 10-2014-0109320
Aug. 22, 2014 (KR) 10-2014-0109321
Nov. 6, 2014 (KR) 10-2014-0153861
Nov. 6, 2014 (KR) 10-2014-0153862
Jan. 22, 2015 (KR) 10-2015-0010872

(51) Int. Cl. H04W 72/04; H04L 1/18; H04W 76/02

(52) U.S. Cl. CPC H04W 72/0413; H04W 76/025; H04L 1/1861

(57) ABSTRACT

The present invention relates to a method of resetting the schedule of a terminal when priority data transmission is requested in communication between the terminal and a base station. That is, the present invention relates to a system and a method for priority data transmission on LTE dual connectivity which improves reliability of the existing communication data in the terminal and performs priority data transmission simultaneously, in which the system for priority data transmission on LTE dual connectivity includes a main base station that allocates a radio resource to a terminal and performs data communication with the terminal, and a sub-base station that performs data communication with the terminal simultaneously with the main base station.

### BACKGROUND OF THE INVENTION

1. Field of the Invention

Exemplary embodiments of the present invention relate to a system and a method for priority data transmission on LTE dual connectivity, and more particularly, to resetting the schedule of a terminal when priority data transmission is requested in communication between the terminal and a base station. That is, exemplary embodiments of the present invention relate to a system and a method for priority data transmission on LTE dual connectivity which improves reliability of the existing communication data in the terminal and performs priority data transmission simultaneously.

2. Description of the Related Art

With rapid propagation of mobile computing based on the wireless internet technology, it has been required to considerably increase a wireless network capacity and it is expected that the amount of traffic used by mobile users will rapidly increase. As a typical solution for satisfying requirements according to an explosive increase of traffic, a method of applying an evolved physical layer technology or allocating an addition spectrum may be considered. However, the physical layer technology has almost reached a theoretical limit and the method of increasing the capacity of a cellular network by allocating additional spectrums cannot be a basic solution.

Accordingly, as a method for efficiently supporting data traffic of users that is explosively increased in a cellular network, methods of providing a service by reducing the size of cells and densely installing more small cells or by using a multilayer cellular network have been studied.

For example, a “method and small cell base station for small cell access control” has been disclosed in Korean Patent Application Publication No. 10-2012-0138063. The method states a step of receiving a call connection request from a first terminal in a small cell base station coverage of a small cell base station with the capacity fully used, a step of selecting an access control object terminal from the first terminal and a plurality of second terminals on the basis of signal quality information of the second terminals operating in the small cell base station coverage and the first terminal receiving the call connection request, and a step of controlling the access control object terminal so that the access control object terminal is moved to or induce to access a macrocell base station or another small cell base station.

However, in this case too, it is impossible to receive services simultaneously from a plurality of base stations composed of a small cell and a small cell or a small cell and a macro base station.

Accordingly, there is a need for a communication way allowing a terminal to simultaneously communicate with a plurality of base stations in order to achieve efficient data communication. However, in order to secure reliability in simultaneous communication with a plurality of base stations, there is a need for a method of efficiently distributing power in accordance with priority in data transmission.

### Documents of Related Art

### Patent Document

Korean Patent Application Publication No. 10-2012-0138063 (Dec. 24, 2012)

### SUMMARY OF THE INVENTION

An object of the present invention is to provide a system and a method for priority data transmission on LTE dual connectivity which reset the schedule of a terminal, when priority data transmission is requested in communication between the terminal and a base station.

Another object of the present invention is to provide a system and a method for priority data transmission on LTE dual connectivity which allow a terminal to perform data communication with a plurality of base stations by allowing the terminal to increase the reliability of the existing communication data and to perform priority data transmission.

In accordance with one aspect of the present invention, a system for priority data transmission on LTE dual connectivity may include a terminal. The terminal comprises an RF unit that transmits/receives wireless signals; and a processor connected with the RF unit.

The processor simultaneously may perform wireless data communication through a main base station allocating a radio resource to the terminal and a sub-base station connected to the main base station, and determine priority for PUCCH/PUSCH in a cell group.

Further, the terminal may limit the capacity of large-capacity uplink data to remove influence on HARQ-ACK transmission due to the large-capacity uplink data.

Further, in a synchronized cell group, the terminal may transmit a signal, using any one order of the order of periodic CSI, non-periodic CSI, and PUSCH without UCI, while considering HARQ-ACK in the highest priority as priority for PUCCH/PUSCH, or the order of non-periodic CSI, periodic CSI, and PUSCH without UCI, while considering HARQ-ACK in the highest priority. Further, in a synchronized cell group, the terminal may transmit a signal, using any one order of the order of periodic CSI, non-periodic CSI, and PUSCH without UCI, while considering HARQ-ACK in the highest priority as priority for PUCCH/PUSCH, or the order of non-periodic CSI, periodic CSI, and PUSCH without UCI, while considering HARQ-ACK in the highest priority. Further, the terminal may transmit a signal with HARQ-ACK and SR in the same priority or with HARQ-ACK in highest priority than SR.

Further, the terminal may transmit a signal with priority of HARQ-ACK=SR>CSI>PUSCH without UCI for PUCCH/PUSCH in a cell group.

Further, the terminal may set different waiting times for data transmission in accordance with priority, using at least any one of a case in which when the existing data transmission is ended within a waiting time, it transmits data with higher priority after the data transmission is ended, a case in which when it is not expected that the existing data transmission is ended within the waiting time, it immediately drops the existing data transmission and transmits data with higher priority, a case in which when the existing data transmission is not ended within the waiting time, it immediately drops the existing data transmission and transmits data with higher priority, and a case in which it neglects transmission of data with higher priority in accordance with application.

Further, the terminal may set different waiting times for data transmission in accordance with priority, using at least any one of a case in which when the existing data transmission is ended within a waiting time, it transmits data with lower priority after the data transmission is ended, a case in which when it is not expected that the existing data transmission is ended within the waiting time, it immediately abandons transmitting data with lower priority, a case in which when the existing data transmission is not ended within the waiting time, it immediately abandons transmitting data with lower priority, and a case in which it neglects transmission of data with lower priority in accordance with application.

In another aspect of the present invention, a system for priority data transmission on LTE dual connectivity includes: a main base station that allocates a radio resource to a terminal; and a terminal that simultaneously performs wireless data communication through a sub-base station connected to the main base station.

The terminal uses any one of distributing spare power of the terminal to the main base station and the sub-base station, when an uplink signal from the terminal and an uplink signal from another terminal are received to the main base station and the sub-base station with a difference of a specific value or less, under 0.33 [msec], of distributing spare power of the terminal to the main base station and the sub-base station, when signals from the main base station and the sub-base station are received to the terminal as downlink signals, with a difference of a specific value or less, under 0.33 [msec], and of changing the largest signal of the signals from the main base station or the sub-base station to the main base station.

In accordance with another aspect of the present invention, a method for priority data transmission on LTE dual connectivity includes: a priority cell PRACH transmission step of transmitting a priority cell PRACH to the main base station from the terminal; and an uplink power control reception step of distributing power to another cell PRACH having lower priority than the priority cell PRACH by means of the terminal, in which when power distribution fails in the upward power control reception step, the terminal stands ready to transmit another cell PRACH, and when the standing-by is finished in a standing-by step, the terminal transmits another cell PRACH.

The method may further include a step that transmits another cell PRACH to the sub-base station from the terminal, when power distribution succeeds in the uplink power control reception step.

Further, the standing ready to transmit another cell PRACH is reallocating power of another cell PRACH after at least any one time of a predetermined time and a random time.

The standing ready to transmit another cell PRACH is not allocating power to the priority cell PRACH, but allocating power to another cell PRACH in order not to stand ready to re-transmit another cell PRACH, when transmitting data with high priority such as emergency data.

Further, the standing ready to transmit another cell PRACH is standing ready to re-transmit another cell PRACH by repeating with the priority cell PRACH, when transmitting data with high priority such as emergency data.

The standing ready to transmit another cell PRACH is standing by until another cell PRACH is not re-transmitted and transmission power is allocated to another cell PRACH, when data with low priority is transmitted.

Further, the standing ready to transmit another cell PRACH is using a specific value within one second as the predetermined time and using a random value under the specific value within one second as the random time.

In accordance with another aspect of the present invention, a method for priority data transmission on LTE dual connectivity includes: a power distribution step of distributing power for SRS transmission from the terminal to the main base station; a standing-by step of standing by when distributed power is not received due to priority lower than those of HARQ-ACK, SR, CSI, and data; and an SRS transmission step of transmitting SRS after standing by in the standing-by step.

The standing-by step may use any one of standing by until power that can be allocated to SRS is generated, of standing by for a predetermined time or a random time, of standing by after changing priority with any one of HARQ-ACK, SR, CSI, and data after the maximum standing-by time, of standing by after reallocating power for SRS in the highest priority than HARQ-ACK, SR, CSI, and data after the maximum standing-by time, and or standing by after reallocating power for SRS in the highest priority than HARQ-ACK, SR, CSI, and data, when reception power of the main base station is low.

Further, the standing-by step uses a specific value within one second as the predetermined time, uses a random value under a specific value within one second as the random time, and uses a specific value within ten seconds as the maximum standing-by time.

According to a system and a method for priority data transmission on LTE dual connectivity of the present invention, it is possible to reset the schedule of a terminal when priority data transmission is requested in communication between the terminal and a base station.

Further, a system and a method for priority data transmission on LTE dual connectivity of the present invention, it is possible to allow a terminal to perform data communication with a plurality of base stations by allowing the terminal to increase the reliability of the existing communication data and to perform priority data transmission.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the configuration of an LTE network according to an exemplary embodiment of the present invention;

FIG. 2 is a diagram illustrating the configuration of dual connectivity when a first base station of FIG. 1 operates as a main base station and a second base station operates independently as a sub-base station;

FIG. 3 is a diagram illustrating the configuration of dual connectivity when the first base station of FIG. 1 operates as a main base station, the second base station operates as a sub-base station, and data is separated and combined through the main base station;

FIG. 4 is a diagram illustrating a configuration in detail when the sub-base station of FIGS. 2 and 3 is disconnected from a terminal;

FIG. 5 is a diagram illustrating a configuration in detail when transmission power for a terminal is allocated to the main base station or the sub-base station of FIGS. 2 and 3;

FIG. 6 is a diagram illustrating a configuration in detail when a terminal randomly accesses the main base station or the sub-base station of FIGS. 2 and 3;

FIG. 7 is a diagram illustrating a method of increasing the performance of a terminal in an area concentrated with small cell base stations according to another exemplary embodiment of the present invention;

FIG. 8 is a diagram illustrating the configuration of a system for priority data transmission on LTE dual connectivity according to another exemplary embodiment of the present invention;

FIG. 9 is a diagram illustrating the configuration of a system for priority data transmission on LTE dual connectivity according to another exemplary embodiment of the present invention;

FIG. 10 is a diagram illustrating a method for priority data transmission on LTE dual connectivity according to another exemplary embodiment of the present invention;

FIG. 11 is a diagram illustrating the configuration of a system for priority data transmission on LTE dual connectivity according to another exemplary embodiment of the present invention;

FIG. 12 is a timing diagram illustrating a method for priority data transmission on LTE dual connectivity according to another exemplary embodiment of the present invention;

FIG. 13 is a timing diagram illustrating a method for priority data transmission on LTE dual connectivity according to another exemplary embodiment of the present invention; and

FIG. 14 is a block diagram illustrating an exemplary wireless communication system for which exemplary embodiments of the present invention can be achieved.

### DESCRIPTION OF SPECIFIC EMBODIMENTS

Detailed exemplary embodiments of the present invention will be described with reference to the accompanying drawings.

The present invention may be modified in various ways and implemented by various exemplary embodiments, so that specific exemplary embodiments are illustrated in the drawings and will be described in detail below. However, it is to be understood that the present invention is not limited to the specific exemplary embodiments, but includes all modifications, equivalents, and substitutions included in the spirit and the scope of the present invention.

Hereinafter, a system and a method for priority data transmission on LTE dual connectivity according to the present invention will be described in detail with reference to the accompanying drawings.

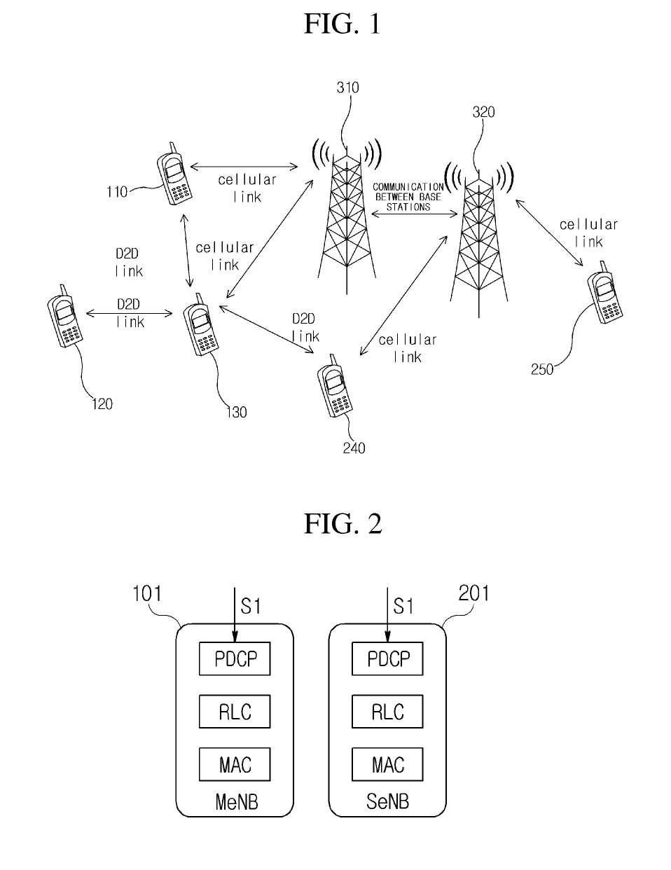

FIG. 1 is a diagram illustrating the configuration of an LTE network according to an exemplary embodiment of the present invention and FIGS. 2 to 6 are diagrams illustrating the configuration of FIG. 1 in detail.

A system for priority data transmission in LTE dual connectivity according to an exemplary embodiment of the present invention is described hereafter with reference to FIGS. 1 to 6.

Referring to FIG. 1 first, an LTE network structure according to an exemplary embodiment of the present invention is composed of base stations and terminals. In particular, new frequencies can be allocated and used for inter-terminal communication, when a macrocell and a D2D channel are specifically allocated.

When a macrocell and a D2D channel are both allocated, inter-terminal communication may be achieved by at least any one of adding a sub-channel and using the physical channel used by the macrocell, and at least any one of a channel allocation scheme, a channel management scheme, and a duplexing method may be used for interference between the macrocell and the D2D channel.

Further, synchronization between terminals may be provided from at least any one of an uplink, a downlink, and both of an uplink and a downlink.

In the LTE network structure, in detail, a first terminal 110 and a third terminal 130 are in the cellular link coverage of a first base station 310, and a fourth terminal 240 and a fifth terminal 250 are in the cellular link coverage of a second base station 320.

The third terminal 130 is positioned at a distance where D2D communication with the first terminal 110, the second terminal 120, and the fourth terminal 240 is available. The D2D link of the third terminal 130 and the first terminal 110 is in the same first base station 310, the D2D link of the third terminal 130 and the fourth terminal 240 is on another cellular coverage, the D2D link of the third terminal 130 and the second terminal 120 is formed by the second terminal 120 not positioned in any cellular coverage and the third terminal 130 positioned in the cellular coverage of the first base station 310.

The cellular link channel used between the first base station 310 and the third terminal 130 and the D2D link channel used by the third terminal 130 and the fourth terminal 240 may be separately or simultaneously allocated.

For example, when the cellular link channel used between the first base station 310 and the third terminal 130 and the D2D link channel used by the third terminal 130 and the fourth terminal 240 use the same frequency, OFDM symbols of PDSCH, PDCCH, PUSCH, and PUCCH may be separately allocated.

In particular, the first base station 310 can carry out an allocation schedule of time slots for transmitting a synchronization signal, a discovery signal, and an HARQ for the D2D link channel used by the third terminal 130 and the fourth terminal 240.

The synchronization signal transmitted by the first base station 310 may be used simultaneously with the information about the cellular link of the first base station 310, but the time slots for transmitting a synchronization signal, a discovery signal, and an HARQ for the third terminal 130 and the fourth terminal 240 may be scheduled not to overlap the time slots of the cellular link channels used between the first base station 310 and the third terminal 130.

When the cellular link channel used between the first base station 310 and the third terminal 130 and the D2D link channel used by the third terminal 130 and the fourth terminal 240 use different frequencies, the third terminal 130 and the fourth terminal 240 can exclusively use the OFDM symbols of PDSCH, PDCCH, PUSCH, and PUCCH, and the third terminal 130 or the fourth terminal 240 can perform scheduling.

D2D communication between the third terminal 130 and the fourth terminal 240 is performed, avoiding interference influenced by the first base station 310 and the first terminal 110. In particular, in the D2D communication between the third terminal 130 and the fourth terminal 240, the third terminal 130 uses any one of a way of transmitting a synchronization signal received from the first base station 310 to the fourth terminal 240 through the uplink channel used by the first base station 310, a way of transmitting the synchronization signal to the fourth terminal 240 through the downlink channel used by the first base station 310, and a way of transmitting the synchronization signal to the fourth terminal 240 through both of the uplink and downlink channels used by the first base station 310.

FIG. 2 is a diagram illustrating a configuration of dual connectivity when the first base station 310 of FIG. 1 operates as a main base station 101 and the second base station 320 operates independently as a sub-base station 201.

The main base station 101 (master eNB) and the sub-base station 201 (secondary eNB), which are used for dual connectivity, are individually connected with a core network.

Accordingly, all of protocols are independent from the main base station 101 and the sub-base station 201, and particularly, data to be transmitted to two base stations is not separated and combined at the base stations.

A PDCP (Packet Data Convergence Protocol) is one of wireless traffic protocol stacks in LTE which compresses and decompresses an IP header, transmits user data, and keeps a sequence number for a radio bearer.

RLC (Radio Link Control) is a protocol stack of controlling wireless connection between a PDCP and MAC.

Further, the MAC (Media Access Control) is a protocol stack supporting multi-access of a wireless channel.

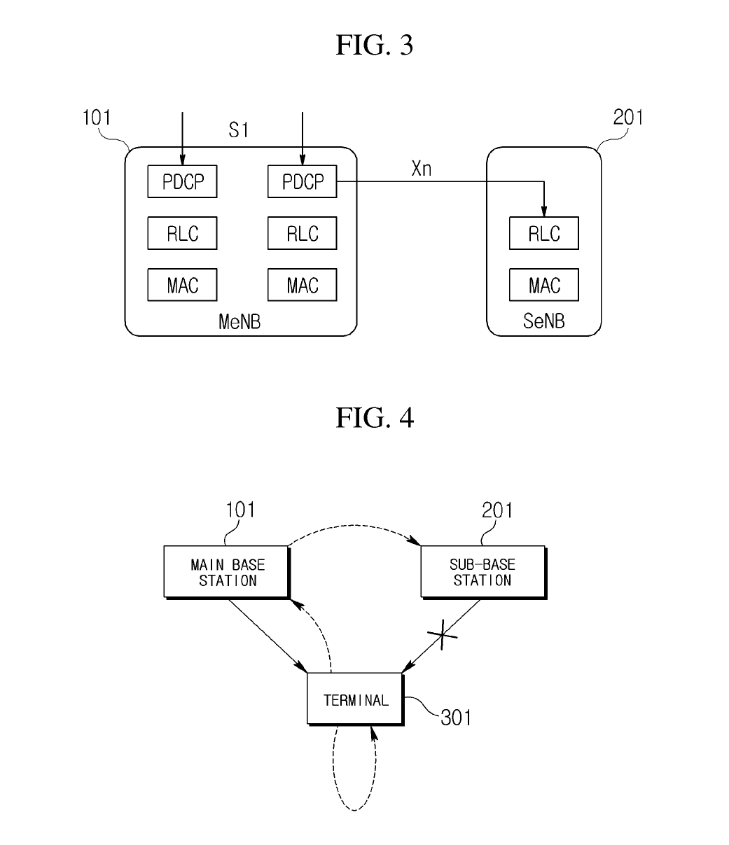

FIG. 3 is a diagram illustrating a configuration of dual connectivity when the first base station 310 of FIG. 1 operates as a main base station 101, the second base station 320 operates as a sub-base station 201, and data is separated and combined through the main base station 101.

That is, when the main base station 101 and the sub-base station 201, which are used for dual connectivity, are connected with a core network, only the main base station 101 is connected with the core network and the sub-base station 201 is connected with the core network through the main base station 101.

Accordingly, data transmitted/received on the core network is separated and combined by the main base station 101. That is, data separated from the main base station 101 is transmitted to the sub-base station 201 or data received from the sub-base station 201 is combined and transmitted/received on the core network.

FIG. 4 is a diagram illustrating a configuration in detail when the sub-base station 201 of FIGS. 2 and 3 is disconnected from a terminal 301.

That is, the system for priority data transmission on LTE dual connectivity includes the main base station 201 that allocates a radio resource to the terminal 301 and performs data communication with the terminal 301, the sub-base station 201 that performs data communication with the terminal 301 simultaneously with the main base station 201, and the terminal 301 that simultaneously performs data communication with the main base station 101 and the sub-base station 201, and resets radio resource control when it unlinks from the sub-base station 201.

When the terminal 301 is not normally connected with the sub-base station 201, it informs the main base station 101 of connection state information and the main base station 101 informs the sub-base station 201 of the link state information between the sub-base station 201 and the terminal 301.

Similarly, when the terminal 301 is connected with the main base station 101, it resets radio resource control and reports it to the sub-base station 201 and the sub-base station 201 reports the abnormal connection to the main base station 101.

The communication between the main base station 101 and the sub-base station 201 may be performed by adding information to a frame in an X2 interface or by a broadband network, and when they are not connected by a wire, wireless backhaul may be used for the communication. A signal system including a link state header showing the link state of the main base station 101 and the sub-base station 201, a link state, a base station ID, and a terminal ID may be used for the information in the frame.

Accordingly, when there is a problem with connection in any one of the main base station 101 and the sub-base station 201, the terminal 301 reports it to any one of the main base station 101 and the sub-base station 201, which has no problem, and the base station receiving the report informs the base station with the problem with connection of the report so that the state of connection with the terminal 301 can be checked.

On the other hand, when there is a problem with connection in both of the main base station 101 and the sub-base station 201, similarly, the terminal 301 resets the radio resource control to allow for communication with the base stations.

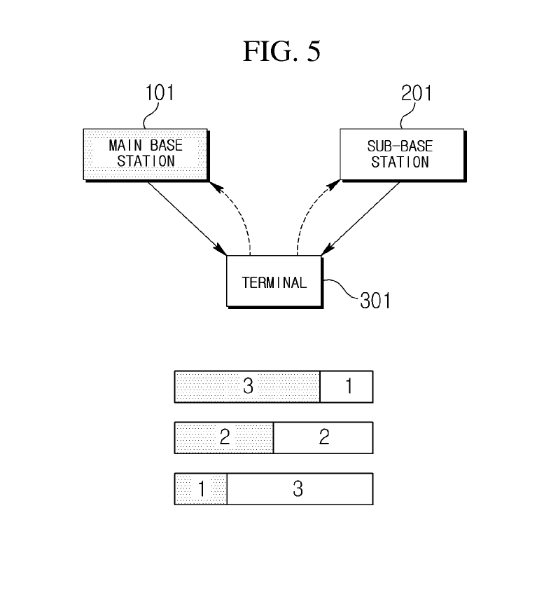

FIG. 5 is a diagram illustrating a configuration in detail when transmission power for the terminal 301 is allocated to the main base station 101 or the sub-base station 201 of FIGS. 2 and 3.

That is, the system for priority data transmission on LTE dual connectivity includes the main base station 101 that allocates a radio resource to the terminal 301 and performs data communication with the terminal 301, the sub-base station 201 that performs data communication with the terminal 301 simultaneously with the main base station 101, and the terminal 301 that sets an upper limit ratio of transmission power for the main base station 101 and the sub-base station 201 on the basis of statistic analysis on power sent out from the main base station 101 and the sub-base station 201.

The statistic analysis is analyzing a transmission power ratio on the basis of the average power sent out from the terminal 301 to the main base station 101 and the sub-base station 201, and the terminal 301 reports the upper limit ratio of transmission power to the main base station 101 and the sub-base station 201.

That is, the terminal 301 sets the power ratio to send out to the main base station 101 and the sub-base station 201 on the basis of the average value of the maximum power, which can be sent out by the terminal 301, and the transmission values sent out to the main base station 101 and the sub-base station 201.

For example, it sets the ratio of power to send out to the main base station 101 and the sub-base station 201 as 3:1, 2:2, and 1:3.

As another example, when power to be sent is distributed, first, it is very important to maintain connectivity with the main base station 101 or transmit a control signal, so, in order to transmit the signal, power may be allocated to the main base station 101 first and then the remaining power may be distributed for data transmission/reception with the sub-base station 201.

As another example, the power available for transmitting data to the sub-base station 201 may be dynamically changed. That is, an MCS (Modulation and Coding Scheme) value may depend on the available power, even if the wireless channel does not change.

A data transmission error may be generated, when the power distribution and the MCS value are simultaneously changed, so that a change of the power distribution and a change of the MCS value may not be simultaneously performed.

Alternatively, when the power distribution and the MCS value are simultaneously changed, a period of reporting a CQI (Channel Quality Indicator) for changing the MCS, which is a feedback signal system, may be set not to be generated simultaneously with the change of the power distribution, in order to prevent a data transmission error.

On the other hand, at least any one of the maximum value of a terminal, the ratio of power that is being used, the maximum transmission power for each base station according to a power ratio, and the margin of the maximum power, which can be transmitted to the base stations, to the power currently sent out to the terminal can be reported to the main base station 101 and the sub-base station 201.

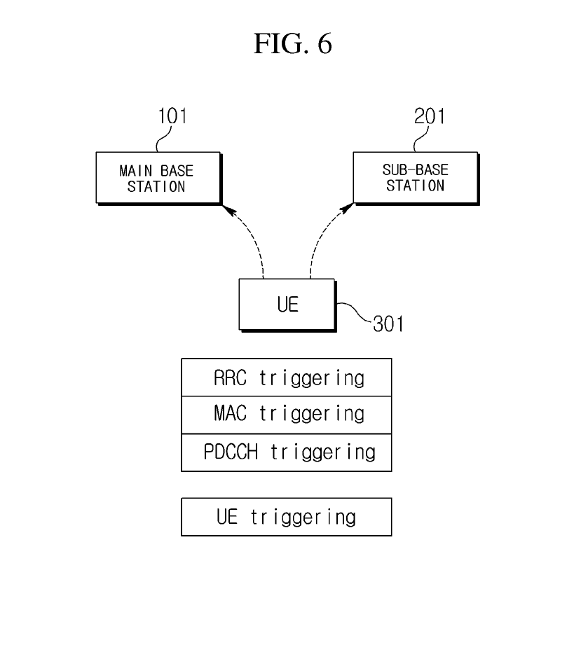

FIG. 6 is a diagram illustrating a configuration in detail when the terminal 301 randomly accesses the main base station 101 or the sub-base station 201 of FIGS. 2 and 3.

That is, the system for priority data transmission on LTE dual connectivity includes the main base station 101 that allocates a radio resource to the terminal 301 and performs data communication with the terminal 301, the sub-base station 201 that performs data communication with the terminal 301 simultaneously with the main base station 101, and the terminal 301 that sends out any one of random access to the main base station 101 and the sub-base station 201 by triggering and self random access to them without triggering to at least any one of the main base station 101 and the sub-base station 201.

The triggering is performed by any one triggering command of PDCCH, MAC, and RRC and the sub-base station 201 includes a base station, which can be accessed first, of base stations that can operate as the sub-base station 201.

The random access is transmitted in any one type of a preamble without contents, initial access, a radio resource control message, and a terminal ID.

That is, the random access, which is used for initial access to the main base station 101 or the sub-base station 201, establishment and re-establishment of radio resource control, and handover, may be sent out to any one of the main base station 101 and the sub-base station 201 or simultaneously to the main base station 101 or the sub-base station 201.

Random access may be sent out by PDCCH, MAC, and RRC (Radio Resource Control) triggering from the main base station 101 or the sub-base station 201, but it may be sent out by triggering of a terminal itself.

Further, random access may be sent out by using the remaining power except for the power distributed to an uplink.

On the other hand, when the main base station 101 or the sub-base station 201 is newly turned on, an error may be generated in data communication due to simultaneous random access of surrounding terminals, including the terminal 301.

Accordingly, in order to reduce such influence, the terminal 301 may perform random access, additionally using a random time around ten seconds, when the main base station 101 or the sub-base station 201 is newly turned on. The ‘ten seconds’ is the maximum random access time that is variable in accordance with the number of terminals and the number of base stations and the maximum random access time may be any one in the range of one second to sixty seconds, depending on the environment.

Meanwhile, since the terminal 301 can use a multi-antenna, it is possible to minimize interference influence by finding the transmission position of the main base station 101 or the sub-base station 201 and performing random access toward the main base station 101 or the sub-base station 201.

Alternatively, when the exact positions of the main base station 101 and the sub-base station 201 are not found, the terminal 301 may perform random access by sweeping at 360 degrees.

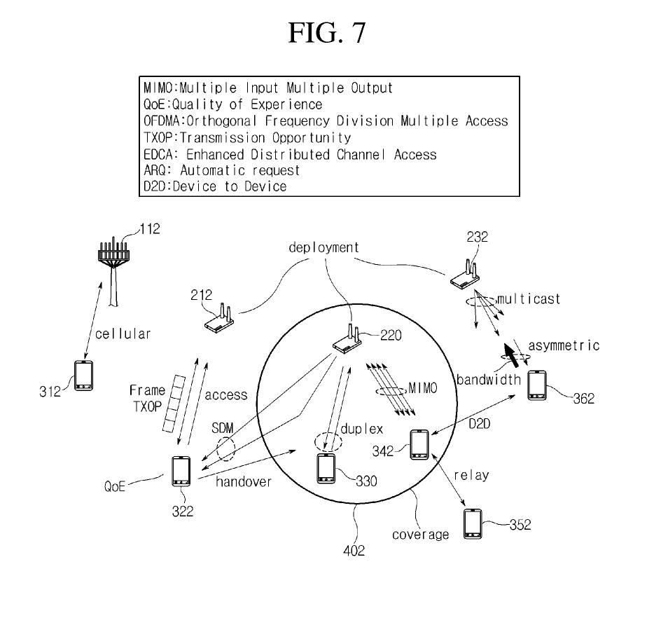

FIG. 7 is a diagram illustrating a method of increasing the performance of a terminal in an area concentrated with small cell base stations according to another exemplary embodiment of the present invention.

The method of increasing the performance of a terminal includes at least any one of a cellular interference removal technique that reduces cellular interference between a base station 112 and a terminal 312, a frame rearrangement technique that efficiently uses the frame between a small cell base station 212 and a terminal 322, a TXOP (Transmit OPportunity) technology that schedules a transmission opportunity between the small cell base station 212 and the terminal 322, an efficient access technique that makes a method of accessing the small cell base station 212 from the terminal 322 efficient, an SDM (Spatial Domain Multiplexing) technique that improves the quality of service provided for the terminal 322 by spatially disposing an antenna between a small cell base station 220 and the terminal 322, an efficient handover technique that ensures efficient conversion when the terminal 322 in the service area of the small cell base station 212 enters the service area of the small cell base station 220 and converts small cell base station connection, an efficient duplex technique that uses more efficiently a duplex way between the small cell base station 220 and the terminal 330, an MIMO (Multiple Input Multiple Output) technique that improves data performance of a terminal 342, using several antennas between the small cell base station 220 and the terminal 342, a relay technique in which the terminal 342 within the service range of the small cell base station 220 relays the information about the small cell base station 220 to a terminal 352 out of the service range of the small cell base station 220, a D2D (Device to Device) technique that performs direct communication between the terminal 342 and a terminal 362, an asymmetric technique that efficiently and differently uses the bandwidths of UL and DL between a small cell base station 232 and the terminal 362, a bandwidth technique that adjusts the bandwidth between the terminal 362 and the small cell base station 232, and a multicast technique that transmits the same data to common users from the small cell base station 232.

The small cell base station 220 transmits PSS (Primary Synchronization Signal), PSS/SSS (Secondary Synchronization Signal), CRS (Cell Specific Reference Signal), CSI-RS (Channel State Indicator—Reference Signal), and PRS to the terminal 330.

Then, PSS, PSS/SSS, CRS, CSI-RS, and PRS signals may be used for measuring time synchronization, frequency synchronization, Cell/TP (Transmission Points) identification, and RSRP (Reference Signal Received Power). CSI-RS is not used for the time synchronization, but RSSI measuring a symbol including/not including a discovery signal is used for measuring RSRQ (Reference Signal Received Power).

The measurement of RSRP and RSRQ may be used in various cases such as muting in a transmitter, and interference removal may be considered in a receiver.

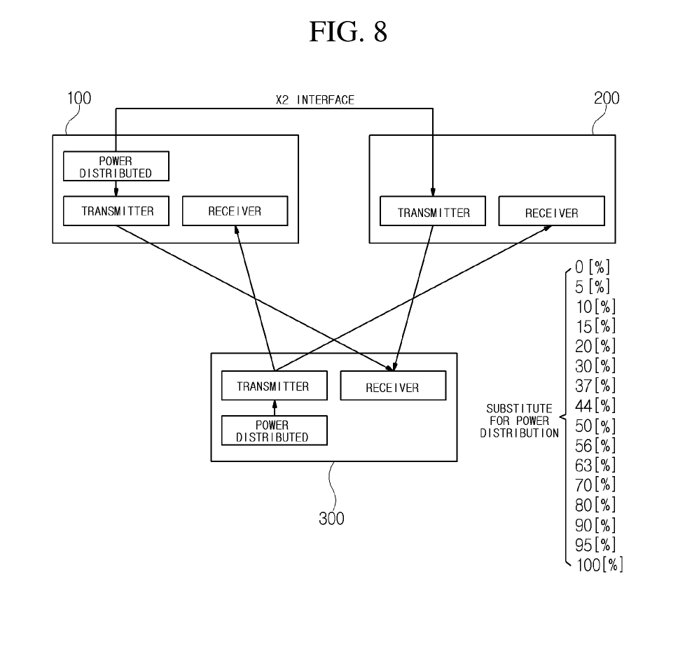

FIG. 8 is a diagram illustrating the configuration of a system for priority data transmission on LTE dual connectivity according to another exemplary embodiment of the present invention. A system for priority data transmission on LTE dual connectivity includes a base station 100 that allocates a radio resource to a terminal 300 and performs data communication with the terminal 300 and a sub-base station 200 that performs data communication with the terminal 300 simultaneously with the main base station 100.

According to an embodiment of the present invention, for simultaneous communication among the main base station 100, the sub-base station 200, and the terminal 300, it is possible to determine substitute value for power allocation in order to distribute power to the main base station 100 and the sub-base station 200 and the substitute value may be transmitted through RRC signaling.

The RRC signaling value for the power distribution may be expressed by percentage showing the ratio of the transmission power to the maximum power which can be ensured in a cell group. For example, when the RRC signaling value is set to 10%, power of 10% of the available power may be allocated to the sub-base station 200 and power of 90% of the available power may be allocated to the main base station 100.

Further, for example, the RRC signaling value may be one of 0[%], 2[%], 5[%], 6[%], 8[%] 10[%], 13[%], 16[%], 20[%], 25[%], 32[%], 37[%], 40[%], 50[%], 60[%], 63[%], 68[%], 75[%], 80[%], 84[%], 87[%], 90[%], 92[%], 95[%], 98[%], and 100[%].

Since power control is the most important for high power and low power, it may be possible to take RRC signaling values distributed relatively densely (for example, distribution of 0, 2, 5, 6, and 8[%] or distribution of 100, 98, 95, and 92[%]) for detailed power control, but the RRC signaling value is not limited to the values described above. In accordance with situations, a percentage between 0 and 100% may be freely selected for the RRC signaling value.

Further, according to an embodiment of the present invention, in order to show a specific number of RRC signaling values in a predetermined number (for example, 4 bits), the terminal 300 may use sixteen values in the range of 0[%] to 100[%] as the RRC signaling value for the ratio of transmission power to the maximum power available in a cell group. In this case, the terminal 300 may select and use sixteen values of the twenty-six percentages as the RRC signaling value.

In addition, the terminal 300 may use sixteen combinations for showing values in 4 bits in the results of fifteen equal division and twenty equal division of 0 to 100 for the RRC signaling value for the ratio of transmission power to the maximum power available in a cell group.

In detail, as described above, since there is a need for detailed power control for high power and low power, the power ratio may be adjusted in twenty equal division, and the power ratio may be adjusted in fifteen equal division for the middle power.

According to this embodiment, the terminal 300 can use 0[%], 5[%], 10[%], 15[%], 20[%], 30[%], 37[%], 44[%], 50[%], 56[%], 63[%], 70[%], 80[%], 90[%], 95[%], and 100[%] as the RRC signaling value for the ratio of transmission power to the maximum power available in a cell group. In this example, low power and high power may include 0[%], 5[%], 10[%], 15[%], and 20[%] obtained by twenty equal division, and middle power may include 30[%], 37[%], 44[%], and 50[%] obtained by fifteen equal division. Further, the value over 50[%] may include 56[%], 63[%], 70[%], 80[%], 85[%], 90[%], 95[%], and 100[%] which are symmetric to 0[%]-50[%].

However, in order to show a specific number of RRC signaling values in predetermined bits (for example, 4 bits), in the above example, sixteen of the seventeen transmission power ratios may be selected and used, except for 85[%] that is the middle of 1/20 unit and 1/15 unit. Further, in order to show a specific number of RRC signaling values in predetermined bits (for example, 4 bits), unlike the above example, sixteen RRC signaling values except for 15[%], which is the middle of 1/20 unit and 1/15 unit, may be used. Further, in some cases, it can be understood by those skilled in the art that sixteen transmission power ratios except for any one of the seventeen transmission power ratio can be used for the RRC signaling value.

Since data is expressed in 4 bits, total sixteen items of data are required. Accordingly, it is possible to create and use sixteen items of data by equally dividing the values from 0 to 100 into fifteen. However, since it is required to discriminate in detail the highest value and the lowest value but not required to discriminate the middle value in detail, it is possible to effectively use 4 bits that can express a power ratio by using data equally divided into twenty for the highest value and the lowest value and data equally divided into ten for the middle value.

For example, when the power transmitted to the sub-base station 200 from the terminal 300 is 90[%] of the maximum power, the power transmitted to the main base station 100 may be 10[%].

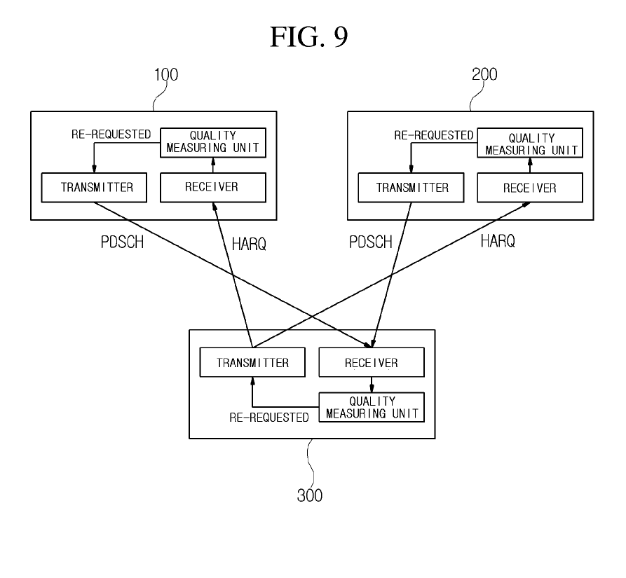

FIG. 9 is a diagram illustrating the configuration of a system for priority data transmission on LTE dual connectivity according to another exemplary embodiment of the present invention.

The terminal 300 may limit the capacity of large-capacity uplink data to remove HARQ-ACK transmission influence (for example, transmission failure and transmission delay) due to large-capacity uplink data.

HARQ-ACK is feedback about the quality of PDSCH at the main base station 100 and the sub-base station 200 and can be transmitted from the terminal 300 to the main base station 100 and the sub-base station 200 through a PUCCH/PUSCH that is an uplink signal.

HARQ-ACK of the main base station 100 may be transmitted only to the Pcell (Primary cell) of the main base station 100 and HARQ-ACK of the sub-base station 200 may be transmitted only to the pScell (primary Secondary cell) of the sub-base station 200 in accordance with predetermined HARQ-ACK timing and multiplexing methods.

The HARQ-ACK may be sent with CSI (Convergence Sublayer Indication) and SR (Scheduling Request) signals and a PUCCH/PUSCH or may be sent in accordance with priority. That is, it is possible to allocate remaining power relating to at least HARQ-ACK for the PUCCH/PUSCH and there is a need for determining priority for the PUCCH/PUSCH throughout a cell group in order to use the remaining power in accordance with a synchronization signal and a non-synchronization signal.

On the other hand, when the main base station 100 and the sub-base station 200 are connected by a backhaul of over 5˜10 [msec], such as in wireless transmission using a microwave for connection between base stations in CoMP (Cooperative Multi-point), which is inter-base station cooperative communication, in transmission using a cable TV network or a wire subscriber line using a DSL (digital subscriber line), and in transmission using an optical subscriber distribution device PON (passive optical network) that is a type of WDM (Wavelength Division Multiplexing), it is difficult to transmit HARQ in real time.

Accordingly, other than the method of transmitting HARQ-ACK in one frame of 10 [ms] in the related art, there is a need for a method capable of transmitting HARQ-ACK after one or more frames.

First, it is possible to measure a delay of the main base station 100 and the sub-base station 200 and define a delay of HARQ-ACK on the basis of the measured delay. In forward transmission, since the terminal 300 transmits HARQ-ACK to the main base station 100 and the sub-base station 200 in real time, it is not a problem.

However, in backward transmission, when the main base station 100 controls HARQ-ACK, the HARQ-ACK may be delayed over one frame due to a delay of backward data received through the sub-base station 200. In this case, the HARQ-ACK for the backward data received by the sub-base station 200 may not be transmitted. That is, when there is an error in both of the backward data received by the main base station 100 and the backward data received by the sub-base station 200, the main base station 100 transmits HARQ-ACK to the terminal 300 and the sub-base station 200 does not transmit HARQ-ACK.

Further, even if here is no error in both of the backward data received by the main base station 100 and the backward data received by the sub-base station 200, the main base station 100 transmits HARQ-ACK to the terminal 300, but the sub-base station 200 may not transmit HARQ-ACK to the terminal 300.

According to an embodiment of the present invention, in a synchronized cell group, the terminal 300 may transmit a signal, using the orders of periodic CSI, non-periodic CSI, and PUSCH without UCI (Uplink Control Information), while considering HARQ-ACK in the highest priority as priority for PUCCH/PUSCH, or the order of any one of non-periodic CSI, periodic CSI, and PUSCH without UCI, while considering HARQ-ACK in the highest priority. Further, in a non-synchronized cell group, the terminal 300 may transmit a signal, using the orders of periodic CSI, non-periodic CSI, and PUSCH without UCI, while considering HARQ-ACK in the highest priority as priority for PUCCH/PUSCH, or the order of any one of non-periodic CSI, periodic CSI, and PUSCH without UCI, while considering HARQ-ACK in the highest priority. Further, the terminal 300 may transmit a signal with HARQ-ACK and SR in the same priority or with the HARQ-ACK in highest priority than SR.

Further, with the HARQ-ACK and SR in the same priority, and then signals may be transmitted in the order of CSI>data>SRS. The SRS (Sounding Reference Signal), which shows whether there is the terminal 300 or not, may be transmitted in the lowest priority or, if necessary, it may not be transmitted.

According to an embodiment of the present invention, the terminal 300 may transmit a signal with priority of HARQ-ACK=SR>CSI>PUSCH without UCI for PUCCH/PUSCH in a cell group. When there is collision of the same types of UCI, the PUCCH channel type may be set in higher priority than the PUSCH channel type. Further, when there is collision of the same types of UCI having the same channel type, an MCG (Master Cell Group) may be set in higher priority than an SCG (Secondary Cell Group).

The present invention can allow efficient allocation of remaining power for a cell group by determining priority for PUCCH/PUSCH.

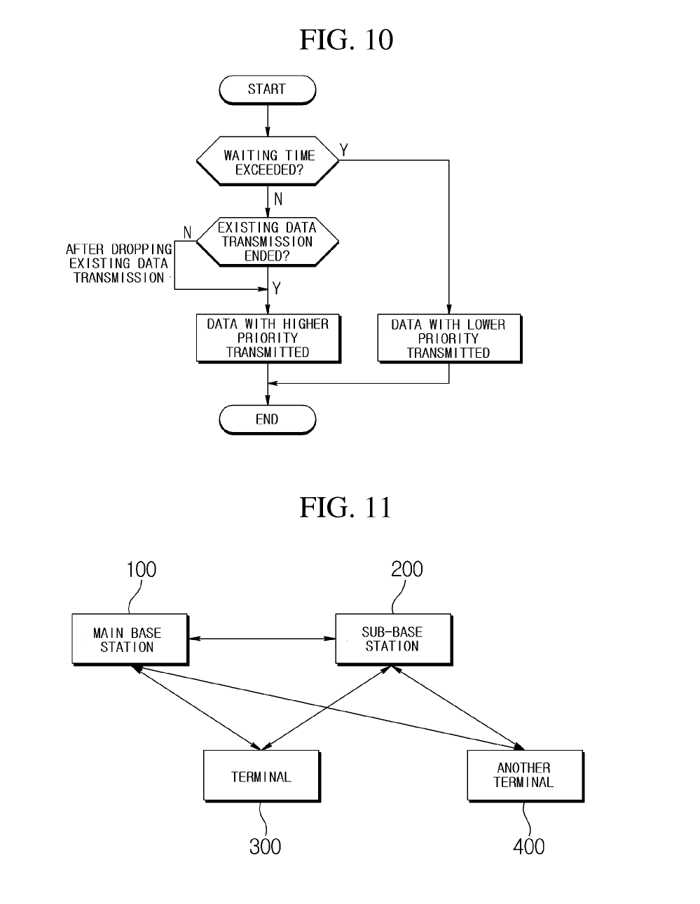

FIG. 10 is a diagram illustrating a method for priority data transmission on LTE dual connectivity according to another exemplary embodiment of the present invention.

The terminal 300 may set different waiting times for data transmission in accordance with priority, using at least any one of a case in which when the existing data transmission is ended within a waiting time, it transmits data with higher priority after the data transmission is ended, a case in which when it is not expected that the existing data transmission is ended within the waiting time, it immediately drops the existing data transmission and transmits data with higher priority, a case in which when the existing data transmission is not ended within the waiting time, it immediately drops the existing data transmission and transmits data with higher priority, and a case in which it neglects transmission of data with higher priority in accordance with application.

On the other hand, the terminal 300 may set different waiting times for data transmission in accordance with priority, using at least any one of a case in which when the existing data transmission is ended within a waiting time, it transmits data with lower priority after the data transmission is ended, a case in which when it is not expected that the existing data transmission is ended within the waiting time, it immediately abandons transmitting data with lower priority, a case in which when the existing data transmission is not ended within the waiting time, it immediately abandons transmitting data with lower priority, and a case in which it neglects transmission of data with lower priority in accordance with application.

FIG. 11 is a diagram illustrating the configuration of a system for priority data transmission on LTE dual connectivity according to another exemplary embodiment of the present invention. The system for priority data transmission on LTE dual connectivity includes a main base station 100 that allocates a radio resource to a terminal 300 and the terminal 300 that simultaneously performs wireless data communication through a sub-base station 200 connected to the main base station 100.

The terminal 300 may use any one of distributing spare power of the terminal 300 to the main base station 100 and the sub-base station 200, when an uplink signal from the terminal 300 and an uplink signal from another terminal 400 are received to the main base station 100 and the sub-base station 200 with a difference of a specific value or less, under 0.33 [msec], of distributing spare power of the terminal 300 to the main base station 100 and the sub-base station 200, when signals from the main base station 100 and the sub-base station 200 are received to the terminal 300 as downlink signals, with a difference of a specific value or less, under 0.33 [msec], and of changing the largest signal of the signals from the main base station 100 or the sub-base station 200 to the main base station 100.

The main base station 100 and the sub-base station 200 are widely installed to provide various communication services such as a voice and packet data to an LTE (Long Term Evolution) or LTE-A (Advanced) system.

Further, the multi-access technique used herein is not limited and various multi-access technique such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA may be used.

A TDD (Time Division Duplex) technique that use different times for uplink transmission and downlink transmission may be used, or an FDD (Frequency Division Duplex) technique that transmits data using different frequencies may be used.

The main base station 100 and the sub-base station 200 communicate with the terminal 300 in a control plane and a user plane, in which the user plane is a protocol stack for data transmission from users and the control plane is a protocol stack for control signal transmission.

The main base station 100 and the sub-base station 200 may be called other names such as an eNodeB (evolved-NodeB), a BTS (Base Transceiver System), an access point, a femto-eNB, a pico-eNB, a Home eNB, and a relay.

Further, the main base station 100 and the sub-base station 200 may be connected through an X2 interface. Layers of a radio interface protocol between the terminal 300 and a network may be classified into a first layer L1, a second layer L2, and a third layer L3 on the basis of three lower layers of a standard model of OSI (Open System Interconnection) that is well known in the field of communication system, in which the physical layer in the first layer provides an information transfer service using a physical channel and an RRC (Radio Resource Control) layer in the third layer controls radio resources between the terminal 300 and a network. To this end, the RRC layer exchanges RRC message among the terminal 300, and the main base station 100 and the sub-base station 200.

The physical layer provides an information transfer service to upper layers, using a physical channel.

The physical layer is connected to a MAC (Medium Access Control) layer, which is an upper layer, through a transport channel. Data is transported between the MAC layer and the physical layer through the transport channel. The transport channel is classified in accordance with how and with which characteristic data is transmitted through a radio interface. Data is transported through a physical channel between different physical layers, that is, between the physical layers of a transmitter and a receiver.

The physical channel may be modulated by OFDM (Orthogonal Frequency Division Multiplexing) and uses time and a frequency as radio resources. The PDCCH (physical downlink control channel), which is a physical control channel, informs the terminal 300 of the information about resource allocation of a PCH (paging channel) and a DL-SCH (downlink shared channel) and HARQ (hybrid automatic repeat request) associated with the DL-SCH.

The PDCCH may transmit an uplink scheduling grant saying resource allocation in uplink transmission to the terminal 300. A PCFICH (physical control format indicator channel) informs the terminal 300 of the number of OFDM symbols for PDCCHs and transmits it at each sub-frame. A PHICH (physical Hybrid ARQ Indicator Channel) transmits a HARQ ACK/NAK signal in response to uplink transmission. A PUCCH (Physical uplink control channel) shows uplink control information such as HARQ ACK/NAK, a scheduling request, and CQI in downlink transmission. A PUSCH (Physical uplink shared channel) transmits an UL-SCH (uplink shared channel).

In an heterogeneous network environment with macrocells and small cells, the small cells provide services for a smaller area than that of the macrocells, so they are advantageous in throughput, which can be provided for a signal terminal 300, as compared with the macrocells.

A dual connectivity technique has been introduced as one of cell planning techniques for distributing excessive load or load requiring specific QoS in the small cell without a process of handover and efficiently transmitting data in a heterogeneous network environment. For the terminal 300, the dual connectivity may be a technique for providing a more efficient way in terms of transmission/reception rates.

For example, the terminal 300 can transmit/receive services to/from two or more serving cells. The serving cells may pertain to different base stations. On the basis of the dual connectivity technique, the terminal 300 can transmit/receive services through wireless communication with two or more different base stations (for example, a macro base station for macrocells and a small base station for small cells) at different frequency bands. Alternatively, the terminal 300 may transmit/receive services through wireless communication with two or more different base stations at the same frequency band.

In the dual connectivity, one terminal 300 performs a mobile communication service to two base stations, so the terminal 300 needs to control power on the basis of the distance difference from the main base station 100 and the sub-base station 200 and it determines the maximum power that the terminal 300 can transmit, and then distributes and transmits power not over the maximum power. Further, the main base station 100 and the sub-base station 200 can receive data equally to another terminal 400 or in accordance with the priority.

The remaining power after the terminal 300 transmits power to any one of the main base station 100 and the sub-base station 200 can be distributed to the main base station 100 and the sub-base station 200 and this distribution can increase the transfer rate by maximally using the remaining power of the terminal.

Power control may be classified into a first power control mode sharing remaining power after the terminal 300 transmits power and a second power control mode using all the remaining power.

The first power control mode determines priority for remaining power on the basis of the type of UCI (Uplink Control Information) of a base station.

Further, the first power control mode is used between the terminal 300 and the terminal 400 that are synchronized. Since the terminal 300 is synchronized, the transmission difference between the terminal 300 and the terminal 400 should not exceed a specific value under 0.33 [msec].

Uplink power control of the terminal 300 may be classified into a synchronization type and a non-synchronization type on the basis of a network signal. That is, the timing difference between the main base station 100 and the sub-base station 200 is less than a specific value under 0.33 [msec], the first power control mode is performed, or when it is larger than the value, the second power control mode is performed.

The time ‘0.33 [msec]’ corresponding to the distance [km] that the main base station 100 can transmit data, considering the speed of an electric wave, or it may correspond to the distance difference between the terminal 300 and the terminal 400 or the distance difference between the main base station 100 and the sub-base station 200. However, a specific value under 0.33 [msec] should be considered in a building due to much reflection of electric waves. In particular, in a service for several kilometers such as a highway, the distance difference between the terminal 300 and the terminal 400 should be considered as a specific value within the distance [km] to the main base station 100 in accordance with the transmission power. For example, when 0.033 [msec] is considered as a specific value, it may be considered that the main base station 100 and the sub-base station 200 have been synchronized within 10 [km] or the terminal 300 and the terminal 400 have been synchronized within 10 [km].

When a parameter relating to the synchronization is set larger than 0.33 [msec], radio signal interference is large when signals are received simultaneously from the main base station 100 and the sub-base station 200, and radio interference is large when signals are received simultaneously from the terminal 300 and the terminal 400, so it becomes a problem in demodulation. In particular, considering one slot period, which is a unit transmission period in LTE, is 0.5 [ms], a parameter relating to synchronization should be within 0.5 [ms] and a specific value that can be considered for synchronization should be determined within 0.33 [ms] in consideration of a margin.

The first power control mode that separately uses remaining power for the main base station 100 and the sub-base station 200 is used when synchronization is made, or when synchronization is not made, they may interfere with each other, so the second power mode only for any one of the main base station 100 and the sub-base station 200 is used.

The power control may fall into a forward power control that controls a transmission channel from a base station to the terminal 300 and a backward power control that controls the power of a transmission signal from the terminal 300.

In the forward power control, the main base station 100 and the sub-base station 200 distributes and efficiently transmits power of PDCCH, PDSCH (Physical Downlink Shared Channel), EPDCCH (Enhanced Physical Downlink Control Channel), PHICH, PCFICH, PMCH (Physical Multicast Channel), and PBCH (Physical Broadcast Channel) in accordance with the terminal 300.

On the other hand, in the backward power control, power is controlled so that it can be received at the same level in consideration of equality of several terminals 300 of which power is received to the main base station 100 and the sub-base station 200, in which information such as HARQ-ACK, SR (Scheduling Request), CSI (Convergence Sublayer Indication), and data that is payload, other than PUCCH, PUSCH transmitting payload, SRS (Sounding Reference Signal) showing whether there is a terminal or not, and PRACH (Physical Random Access CHannel) requesting connection with the main base station 100 and the sub-base station 200, is transmitted and power for the information is controlled.

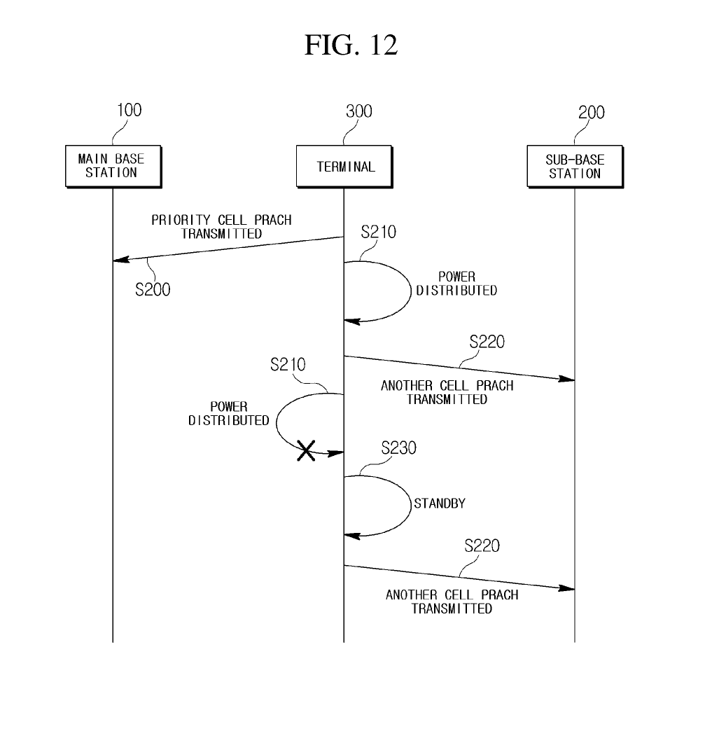

FIG. 12 is a timing diagram illustrating a method for priority data transmission on LTE dual connectivity according to another exemplary embodiment of the present invention. The method for priority data transmission on LTE dual connectivity may include a priority cell PRACH transmission step (S200) that transmits a priority cell PRACH to the base station 100 from the terminal 300 and an uplink power control reception step (S210) that distributes power to another cell PRACH having lower priority than the priority cell PRACH by means of the terminal 300. When power distribution fails in the upward power control reception step (S210), the terminal 300 stands ready to transmit another cell PRACH, and when the standing-by is finished in a standing-by step (S230), the terminal 300 can transmit another cell PRACH (S220).

Further, when power distribution succeeds in the uplink power control reception step (S210), the terminal 300 can transmit another cell PRACH to the sub-base station 200 (S220).

Further, by standing ready to transmit another cell PRACH, it is possible to reallocate the power of another cell PRACH after a predetermined time and a random time.

Standing read to transmit another PRACH is characterized by not allocating power to the priority cell PRACH, but allocating power to another cell PRACH in order not to stand ready to re-transmit another cell PRACH, when transmitting data with high priority such as emergency data.

Further, by standing ready to transmit another cell PRACH, it is possible to stand ready to re-transmit another cell PRACH by repeating with a priority cell PRACH, when transmitting data with high priority such as emergency data.

By standing ready to transmit another cell PRACH, it is possible to standing by until another cell PRACH is not re-transmitted and transmission power is allocated to another cell PRACH, when data with low priority is transmitted.

Further, by standing ready to transmit another cell PRACH, it is possible to use a specific value within one second as a predetermined time and use a random value under the specific value within one second as a random time.

That is, the PRACH is a signal transmitted for connection with the main base station 100 before the terminal 300 communicates with the main base station 100. The signal cannot exceed predetermined power in the terminal 300 and there are several base stations, so the terminal 300 can discriminates a priority cell to which the main base station 100 pertains and another cell to which the sub-base station 200 pertains.

Accordingly, the terminal 300 is composed of a priority cell PRACH that is a PRACH signal to be transmitted to a priority cell, another cell PRACH that is a signal to be transmitted to another cell, and other channels to be transmitted to the main base station 100 other than the PRACHs.

When there is a limit in transmission power of the terminal 300, the priority for PRACH transmission is set in order of priority cell PRACH>another cell PRACH>another channel.

When insufficient power is allocated for low priority and another cell PRACH is dropped and cannot be transmitted, the physical layer notify it to the MAC and does not perform power ramping for re-transmission of the PRACH.

Further, power for another cell PRACH is reallocated after any one of a predetermined time and a random time.

Meanwhile, when data with higher priority is transmitted, another cell PRACH is re-transmitted without a standing-by time or another cell PRACH is re-transmitted by repeating with the priority cell PRACH.

When a data with lower priority is transmitted, another cell PRACH is not re-transmitted and stands by until power is allocated.

That is, when another cell PRACH is not transmitted, it may be a problem when the terminal 300 performs handover to another cell while moving. Accordingly, another cell PRACH is lower in priority than the priority cell PRACH, but the another cell PRACH is transmitted after a predetermined time or a random time.

Further, in order to transmit/receive data with higher priority, another cell PRACH is transmitted simultaneously or repeatedly with the priority cell PRACH without a standing-by time.

Further, in order to transmit/receive data with lower priority, transmission of another cell PRACH is held until power is allocated.

The PRACHs are physically transmitted to an uplink signal transmitted from the terminal 300, simultaneously with PUCCH (Physical Uplink Control Channel), PUSCH (Physical Uplink Shared Channel), SRS (Sounding Reference Signal). Further, through those efficient transmission steps of PRACHs, the terminal 300 can effectively transmit data with higher priority and can rapidly perform handover to another cell.

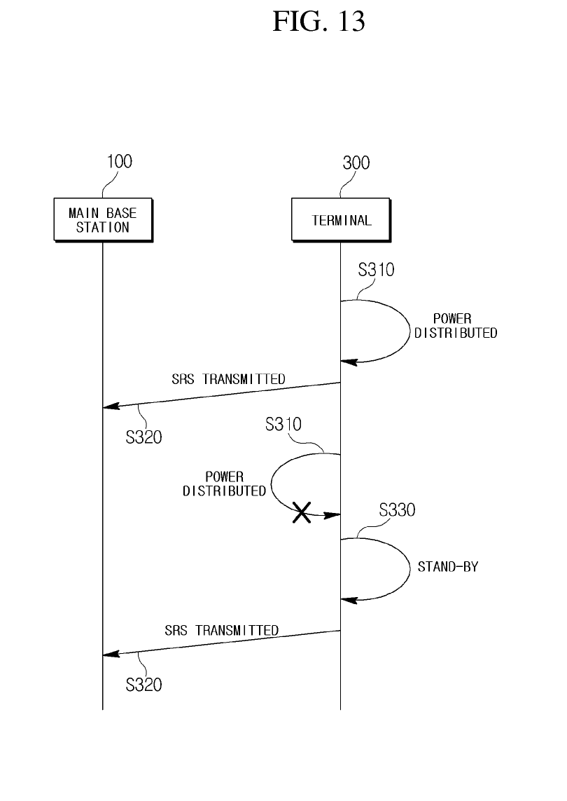

FIG. 13 is a timing diagram illustrating a method for priority data transmission on LTE dual connectivity according to another exemplary embodiment of the present invention. The method for priority data transmission on LTE dual connectivity may include a power distribution step (S310) that distributes power for SRS transmission from the terminal 300 to the main base station 100, a standing-by step (S330) that stands by when distributed power is not received due to priority lower than those of HARQ-ACK, SR, CSI, and data, and an SRS transmission step (S320) that transmits SRS after standing by in the standing-by step (S330).

The standing-by step (S330) may use any one of standing by until power that can be allocated to SRS is generated, of standing by for a predetermined time or a random time, of standing by after changing priority with any one of HARQ-ACK, SR, CSI, and data after the maximum standing-by time, of standing by after reallocating power for SRS in the highest priority than HARQ-ACK, SR, CSI, and data after the maximum standing-by time, and of standing by after reallocating power for SRS in the highest priority than HARQ-ACK, SR, CSI, and data, when reception power of the main base station 100 is low.

Further, in the standing-by step (S330), a specific value within one second is used as a predetermined time, a random value under a specific value within one second is used as a random time, and a specific value within ten seconds may be used as the maximum standing-by time.

The terminal 300 transmits SRS showing whether there is the terminal 300 or not to the main base station 100 and transmits HARQ-ACK, SR, CSI, and data that is pay load after determining their priority.

The terminal 300 allocates remaining power in order of HARQ-ACK & SR>CSI>data>SRS in the first power control mode, for the main base station 100.

The SRS, which is a reference signal transmitted from the terminal 300 to the main base station 100, is periodically transmitted, the main base station 100 determines channel quality for selectively scheduling a frequency from the SRS, checks a timing alignment state, and reports the result to the terminal 300, and it may estimate a channel from the SRS when there is no uplink data.

When the maximum power of the terminal 300 is exceeded while SRS is transmitted to the main base station 100 or the sub-base station 200, the terminal 300 may stop transmission of the SRS or may transmit the SRS after changing the priority of the SRS with any one of HARQ-ACK & SR, CSI, and Data after any one of a predetermined time or a random time. Meanwhile, when the maximum standing-by time is exceeded, it transmits SRS immediately in the highest priority.

That is, the SRS is transmitted in the lowest priority to the main base station 100, but the main base station 100 determines the channel quality for selectively scheduling a frequency using the SRS information, so the SRS should be periodically transmitted within a predetermined time.

Accordingly, when the power of the terminal 300 exceeds the maximum value while SRS is transmitted in accordance with the priority, SRS transmission is stopped, but after a predetermined time or a random time, it is possible to transmit the SRS after changing the priority with any one of HARQ-ACK & SR, CSI, and Data or transmit the SRS in the highest priority when the maximum standing-by time is exceeded.

That is, when SRS transmission is stopped, the priority may be considered as HARQ-ACK & SR>CSI>data, and the priority is changed into any one of HARQ-ACK & SR>CSI>SRS>data, HARQ-ACK & SR>SRS>CSI>data, and SRS>HARQ-ACK & SR>CSI>data, and particularly, for SRS>HARQ-ACK & SR>CSI>data, the SRS is transmitted in the highest priority.

On the other hand, when the reception power of the main base station 100 is low and handover is expected, it prepares for handover by transmitting SRS in the highest priority and enables the sub-base station 200 to measure the channel quality for selectively scheduling a frequency.

The terminal 300 estimates a channel when transmitting data and it transmits data by rapidly recognizing a change in frequency selective fading and scheduling a frequency with a better channel state in motion, in which the frequency selective fading rapidly changes, as time passes.

In particular, over 1 [sec] to 2[sec], the frequency selective fading completely changes at a walking speed, so the terminal 300 has to perform scheduling for a frequency by transmitting SRS, using at least any one of a specific value within 1[sec] and a random value within 1[sec].

Further, over 10[sec], handover may be considered in motion, so RSR has to be transmitted after 10[sec] to prevent this influence.

The SRS is physically transmitted simultaneously with PUCCH (Physical Uplink Control Channel), PUSCH (Physical Uplink Shared Channel), PRACH (Physical Random Access Channel) in an uplink signal transmitted from the terminal 300.

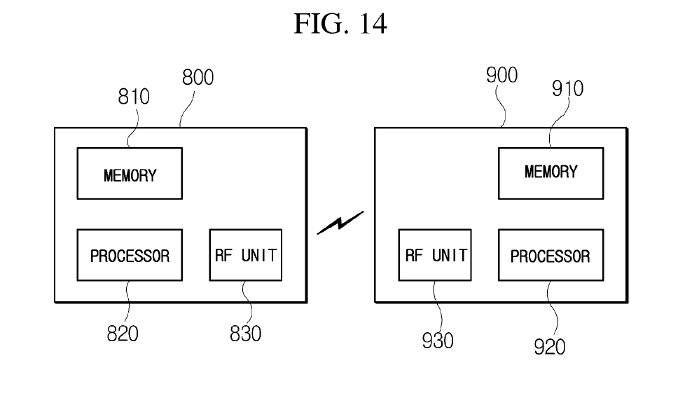

FIG. 14 is a block diagram illustrating an exemplary wireless communication system for which exemplary embodiments of the present invention can be achieved. The wireless communication system shown in FIG. 14 may include at least one base station 800 and at least one terminal 900.

The base station 800 may include a memory 810, a processor 820, and an RF unit 830. The memory 810 is connected with the processor 820 and can keep commands and various terms of information for activating the processor 820. The RF unit 830 is connected with the processor 820 and can transmit/receive wireless signals to/from an external entity. The processor 820 can execute the operations of the base stations in the embodiments described above. In detail, the operations of the base stations 100, 101, 112, 200, 201, 212, 220, 232, 310, and 320 etc. in the embodiments described above may be achieved by the processor 820.

The terminal 900 may include a memory 910, a processor 920, and an RF unit 930. The memory 910 is connected with the processor 920 and can keep commands and various terms of information for activating the processor 920. The RF unit 930 is connected with the processor 920 and can transmit/receive wireless signals to/from an external entity. The processor 920 can execute the operations of the terminals in the embodiments described above. In detail, the operations of the terminals 110, 120, 130, 240, 250, 300, 312, 322, 330, 342, 352, and 362 etc. in the embodiments described above may be achieved by the processor 920.

The present invention may be modified in various ways and implemented by various exemplary embodiments, so that specific exemplary embodiments are shown in the drawings and will be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention. The term ‘and/or’ includes a combination of a plurality of items or any one of a plurality of terms.

It should be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In one or more exemplary embodiments, the described functions may be achieved by hardware, software, firmware, or combinations of them. If achieved by software, the functions can be kept or transmitted as one or more orders or codes in a computer-readable medium. The computer-readable medium includes all of communication media and computer storage media including predetermined medial facilitating transmission of computer programs from one place to another place.

If achieved by hardware, the functions may be achieved in one or more ASICs, DSPs, DSPDs, PLDs, FPGAs, processors, controllers, microcontrollers, microprocessors, other electronic units designed to perform the functions, or combinations of them.

If achieved by software, the functions may be achieved by software codes. The software codes may be kept in memory units and executed by processors. The memory units may be achieved in processors or outside processors, in which the memory units may be connected to processors to be able to communicate by various means known in the art.

Although the present invention was described above with reference to exemplary embodiments, it should be understood that the present invention may be changed and modified in various ways by those skilled in the art, without departing from the spirit and scope of the present invention described in claims.

What is claimed is:

1. A system for priority data transmission on dual connectivity, the system comprising a terminal,
the terminal comprises:
an RF unit that transmits/receives wireless signals; and
a processor connected with the RF unit,
wherein the processor simultaneously performs wireless data communication through a main base station allocating a radio resource to the terminal and a sub-base station connected to the main base station, and determines priority for PUCCH/PUSCH in a cell group.

2. The system of claim 1, wherein the terminal transmits a signal considering the priority for PUCCH/PUSCH in a cell group as HARQ-ACK=SR>CSI>PUSCH without UCI.

3. The system of claim 1, wherein the terminal, in a synchronized cell group, transmits a signal, using any one order of the order of periodic CSI, non-periodic CSI, and PUSCH without UCI, while considering HARQ-ACK in the highest priority as priority for PUCCH/PUSCH, or the order of non-periodic CSI, periodic CSI, and PUSCH without UCI, while considering HARQ-ACK in the highest priority,
the terminal, in a synchronized cell group, transmits a signal, using any one order of the order of periodic CSI, non-periodic CSI, and PUSCH without UCI, while considering HARQ-ACK in the highest priority as priority for PUCCH/PUSCH, or the order of non-periodic CSI, periodic CSI, and PUSCH without UCI, while considering HARQ-ACK in the highest priority, and
the terminal transmits a signal with HARQ-ACK and SR in the same priority or with HARQ-ACK in the highest priority than SR.

4. The system of claim 1, wherein when the existing data transmission is ended within a waiting time, the terminal transmits data with higher priority after the data transmission is ended.

5. The system of claim 1, wherein when it is not expected that the existing data transmission is ended within the waiting time, the terminal immediately drops the existing data transmission and transmits data with higher priority.

6. The system of claim 1, wherein when the existing data transmission is not ended within the waiting time, the terminal immediately drops the existing data transmission and transmits data with higher priority.

7. The system of claim 1, wherein the terminal neglects transmission of data with higher priority in accordance with application.

8. The system of claim 1, wherein when the existing data transmission is ended within the waiting time, the terminal transmits data with lower priority after the data transmission is ended.

9. The system of claim 1, wherein the terminal sets different waiting times for data transmission in accordance with priority, using at least any one of a case in which when it is not expected that the existing data transmission is ended within the waiting time, it immediately abandons transmitting data with lower priority, a case in which when the existing data transmission is not ended within the waiting time, it immediately abandons transmitting data with lower priority, and a case in which it neglects transmission of data with lower priority in accordance with application.

10. The system of claim 1, wherein the terminal uses any one of distributing spare power of the terminal to the main base station and the sub-base station, when an uplink signal from the terminal and an uplink signal from another terminal are received to the main base station and the sub-base station with a difference of a specific value or less, under 0.33 [msec], of distributing spare power of the terminal to the main base station and the sub-base station, when signals from the main base station and the sub-base station are received to the terminal as downlink signals, with a difference of a specific value or less, under 0.33 [msec], and of changing the largest signal of the signals from the main base station or the sub-base station to the main base station.

11. A method for priority data transmission on dual connectivity, the method comprising:
a priority cell PRACH transmission step of transmitting a priority cell PRACH to the main base station from the terminal; and
an uplink power control reception step of distributing power to another cell PRACH having lower priority than the priority cell PRACH by means of the terminal,
wherein when power distribution fails in the upward power control reception step, the terminal stands ready to transmit another cell PRACH, and when the standing-by is finished in a standing-by step, the terminal transmits another cell PRACH.

12. The method of claim 11, further comprising a step that transmits another cell PRACH to the sub-base station from the terminal, when power distribution succeeds in the uplink power control reception step.

13. The method of claim 11, wherein the standing ready to transmit another cell PRACH is reallocating power of another cell PRACH after at least any one time of a predetermined time and a random time.

14. The method of claim 11, wherein the standing ready to transmit another cell PRACH is not allocating power to the priority cell PRACH, but allocating power to another cell PRACH in order not to stand ready to re-transmit another cell PRACH, when transmitting data with high priority such as emergency data.

15. The method of claim 11, wherein the standing ready to transmit another cell PRACH is standing ready to re-transmit another cell PRACH by repeating with the priority cell PRACH, when transmitting data with high priority such as emergency data.

16. The method of claim 11, wherein the standing ready to transmit another cell PRACH is standing by until another cell PRACH is not re-transmitted and transmission power is allocated to another cell PRACH, when data with low priority is transmitted.

17. The method of claim 13, wherein the standing ready to transmit another cell PRACH is using a specific value within one second as the predetermined time and using a random value under the specific value within one second as the random time.

18. A method for priority data transmission on dual connectivity, the method comprising:
a power distribution step of distributing power for SRS transmission from the terminal to the main base station;
a standing-by step of standing by when distributed power is not received due to priority lower than those of HARQ-ACK, SR, CSI, and data; and
an SRS transmission step of transmitting SRS after standing by in the standing-by step.

19. The method of claim 18, wherein the standing-by step uses any one of standing by until power that can be allocated to SRS is generated, of standing by for a predetermined time or a random time, of standing by after changing priority with any one of HARQ-ACK, SR, CSI, and data after the maximum standing-by time, of standing by after reallocating power for SRS in the highest priority than HARQ-ACK, SR, CSI, and data after the maximum standing-by time, and of standing by after reallocating power for SRS in the highest priority than HARQ-ACK, SR, CSI, and data, when reception power of the main base station is low.

20. The method of claim 18, wherein the standing-by step uses a specific value within one second as the predetermined time, uses a random value under a specific value within one second as the random time, and uses a specific value within ten seconds as the maximum standing-by time.
